(19) United States
(12) Patent Application Publication
(10) Pub. No.: US 2025/0085441 A1
(43) Pub. Date: Mar. 13, 2025

(54) Joint GNSS-Terrestrial AP Geolocating

(71) Applicant: Cisco Technology, Inc., San Jose, CA (US)

(72) Inventors: Peiman Amini, Fremont, CA (US); Ardalan Alizadeh, Campbell, CA (US); Jerome Henry, Pittsboro, NC (US); Arya Fallahi, Oberengstingen (CH); Navid Reyhanian, Fremont, CA (US)

(21) Appl. No.: 18/466,659

(22) Filed: Sep. 13, 2023

(51) Int. Cl. G01S 19/46

(52) U.S. Cl. CPC G01S 19/46

(57) ABSTRACT

Described herein are devices, systems, methods, and processes for estimating the geolocation of network devices by jointly utilizing pseudorange measurements from global navigation satellite system (GNSS) satellites and terrestrial-based ranging measurements between network devices. Each network device is equipped with a GNSS receiver that collects pseudorange data from each satellite link at time intervals. Terrestrial-based ranging measurements between network devices can also be collected. The receiver clock error can be accounted for at least in part by over-the-air time synchronization of network devices. To mitigate the impact of multipath and improve accuracy, pseudorange measurements with less than satisfactory quality metrics can be filtered out. In some embodiments, the geolocation of anchor network devices can be estimated with high accuracy first, and then the rest of the non-anchor network devices may be localized in a second-stage localization process.

The present disclosure relates to geolocation estimation. More particularly, the present disclosure relates to estimating the geo-position of network devices using pseudorange measurements from global navigation satellite system (GNSS) satellites and terrestrial-based ranging measurements between network devices.

### BACKGROUND

In the field of wireless communication, accurately determining the geolocation (geo-position) of network devices (e.g., access points (APs)) may be important. This is particularly challenging in indoor environments where the line-of-sight to satellites, which is essential for global navigation satellite system (GNSS)-based geolocating, is often obstructed. In other words, in many indoor environments, the obstruction of the line-of-sight between satellites and the antenna of the GNSS receiver (which can be included in a network device) can cause GNSS-based geolocating to degrade or fail completely.

In such scenarios, just a few network devices located closer to windows may be able to get accurate geolocation estimates, while the rest may not get any fix. This results in an inefficient and ineffective locationing solution. Furthermore, the reliance on GNSS-based geolocating alone may not take into account other available measurements such as terrestrial-based ranging measurements between network devices.

Additionally, the current approaches of geolocation estimation may not fully utilize all available data. For instance, pseudoranges that are available for some network devices may not be used in the geolocating. This leads to a sub-optimal solution that does not maximize the potential of the available data. Therefore, there is a need for a more efficient and accurate approach for estimating the geolocation of network devices, particularly in indoor environments where the line-of-sight to satellites may be obstructed.

### SUMMARY OF THE DISCLOSURE

Systems and methods for estimating the geo-position of network devices using pseudorange measurements from global navigation satellite system (GNSS) satellites and terrestrial-based ranging measurements between network devices in accordance with embodiments of the disclosure are described herein. In some embodiments, a network node includes a processor, at least one network interface controller configured to provide access to a network, and a memory communicatively coupled to the processor, wherein the memory includes a geolocation logic. The logic is configured to collect a plurality of pseudorange measurements from a first set of network devices, each network device in the first set of network devices including a respective global navigation satellite system (GNSS) receiver for obtaining one or more pseudorange measurements, collect one or more inter-network device ranging measurements from a second set of network devices, the second set of network devices sharing at least one network device with the first set of network devices, and determine, for each network device in a third set of network devices, a geo-position based at least in part on at least some of the plurality of pseudorange measurements and at least some of the one or more inter-network device ranging measurements, the third set of network devices including one or more first network devices in the first set of network devices and one or more second network devices in the second set of network devices.

In some embodiments, at least one network device in the first set of network devices or the second set of network devices corresponds to an access point (AP).

In some embodiments, the plurality of pseudorange measurements is collected during one or more time intervals.

In some embodiments, each pseudorange measurement in the plurality of pseudorange measurements is associated with a timestamp.

In some embodiments, measurement in the plurality of pseudorange measurements is associated with a satellite identifier (ID) or a constellation ID.

In some embodiments, each pseudorange measurement in the plurality of pseudorange measurements is associated with a quality metric.

In some embodiments, a network node, wherein the geolocation logic is further configured to discard at least one pseudorange measurement based on the quality metric associated with the at least one pseudorange measurement being less than a threshold.

In some embodiments, the quality metric includes a carrier-to-noise power density ratio (C/N0) metric or a code-minus-carrier (CMC) metric.

In some embodiments, the geolocation logic is further configured to receive ephemeris data associated with the plurality of pseudorange measurements.

In some embodiments, the ephemeris data is received via the first set of network devices.

In some embodiments, the ephemeris data is received from a precise point positioning (PPP) server.

In some embodiments, the plurality of pseudorange measurements is associated with synchronized GNSS receiver clocks at the first set of network devices, and the plurality of pseudorange measurements is associated with a same time-distance offset.

In some embodiments, to determine the geo-position, the geolocation logic is further configured to estimate a GNSS receiver clock error associated with the plurality of pseudorange measurements.

In some embodiments, each network device in the third set of network devices is an anchor network device, and the geolocation logic that is further configured to collect one or more additional inter-network device ranging measurements from a fourth set of network devices, the fourth set of network devices sharing one or more network devices with the third set of network devices, the fourth set of network devices including one or more non-anchor network devices, and determine, for each non-anchor network device in the one or more non-anchor network devices, a non-anchor geo-position based at least in part on at least some of the one or more additional inter-network device ranging measurements.

In some embodiments, a number of observable satellites associated with each anchor network device is greater than a first threshold.

In some embodiments, a number of ranging links associated with each anchor network device is greater than a second threshold.

In some embodiments the one or more inter-network device ranging measurements are based on at least one of fine time measurement (FTM), ultra-wideband (UWB), or high-accuracy distance measurement (HADM).

In some embodiments, a network device includes a processor, at least one network interface controller configured to provide access to a network, and a memory communicatively coupled to the processor, wherein the memory includes a geolocation logic. The is configured to obtain one or more pseudorange measurements via a global navigation satellite system (GNSS) receiver, obtain one or more inter-network device ranging measurements to one or more other network devices, transmit an indication of the one or more pseudorange measurements and an indication of the one or more inter-network device ranging measurements to a network node, and receive an indication of a geo-position of the network device from the network node.

In some embodiments, the geolocation logic is further configured to synchronize a GNSS receiver clock over-the-air with at least one other network device.

In some embodiments, a method for joint geolocating includes collecting a plurality of pseudorange measurements from a first set of network devices, each network device in the first set of network devices including a respective global navigation satellite system (GNSS) receiver for obtaining one or more pseudorange measurements, collecting one or more inter-network device ranging measurements from a second set of network devices, the second set of network devices sharing at least one network device with the first set of network devices, and determining, for each network device in a third set of network devices, a geo-position based at least in part on at least some of the plurality of pseudorange measurements and at least some of the one or more inter-network device ranging measurements, the third set of network devices including one or more first network devices in the first set of network devices and one or more second network devices in the second set of network devices.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a floorplan with a plurality of network devices in accordance with various embodiments of the disclosure;

FIG. 2 is a conceptual illustration of a network depicting non-line-of-sight to one or more global navigation satellite system (GNSS) satellites in accordance with various embodiments of the disclosure;

FIG. 3 is a diagram illustrating a system environment in accordance with various embodiments of the disclosure;

FIG. 4 is a flowchart showing a process for estimating the geolocation of network devices using pseudorange measurements and inter-network device ranging measurements in accordance with various embodiments of the disclosure;

FIG. 5 is a flowchart showing a process for estimating the geolocation of network devices using pseudorange measurements and inter-network device ranging measurements in accordance with various embodiments of the disclosure;

FIG. 6 is a flowchart showing a process for estimating the geolocation of network devices using a two-stage approach in accordance with various embodiments of the disclosure;

FIG. 7 is a flowchart showing a process for estimating the geolocation of a network device in accordance with various embodiments of the disclosure; and

FIG. 8 is a conceptual block diagram for one or more devices capable of executing components and logic for implementing the functionality and embodiments described above in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that estimate the geolocation of network devices (e.g., wireless network devices such as, but not limited, to access points (APs)) by jointly utilizing pseudorange measurements from global navigation satellite system (GNSS) satellites and terrestrial-based ranging measurements between network devices. Herein ranging may refer to the process of determining the distance between two network devices, often by measuring the time it takes for a signal to travel from one network device to the network device (one way or roundtrip). This approach can enhance both the availability and accuracy of positioning, particularly for network devices deployed indoors where the line-of-sight to satellites is often obstructed. Hereinafter terms including geo-positioning, geolocalization, localization, geolocating, or geolocation may be used interchangeably. Any of the terms may refer to the process of determining or estimating the geographic position (e.g., geographic coordinates including latitude, longitude, and/or altitude) of an object (e.g., a wireless network device such as an AP).

In many embodiments, at least some network devices may each be equipped with a GNSS receiver that collects pseudorange data from satellite links at time intervals. By way of a non-limiting example, a GNSS receiver may make a pseudorange measurement to an observable satellite (e.g., per satellite per link) in each time epoch (e.g., every 1 second, every 2 seconds, etc.). The network devices may report the pseudorange data to a central unit. In a number of embodiments, the central unit may be co-located or implemented at one of the network devices being geolocalized. In a variety of embodiments, the central unit may be implemented at a remote device (e.g., a management device) that is not being geolocalized. In some embodiments, the pseudorange data can be timestamped (e.g., based on the satellite time, which may include a time of week (TOW) and a week number). The pseudorange data report may also include other data such as, but not limited to, the carrier-to-noise power density ratio (C/N0) metric and/or the satellite/constellation identifier (ID). In more embodiments, the central unit may receive the ephemeris (i.e., the satellite navigation data) from network devices equipped with a GNSS receiver or from a separate server (e.g., a precise point positioning (PPP) server).

In additional embodiments, the network devices may also obtain and collect terrestrial-based inter-network device ranging measurements between each other. The ranging measurements can be made via Wi-Fi-based or non-Wi-Fi based techniques. A non-limiting example of a Wi-Fi-based approach may be fine time measurement (FTM). Further, non-limiting examples of non-Wi-Fi-based approaches can include ultra-wideband (UWB) or high-accuracy distance measurement (HADM). Because the network devices (including GNSS receiver) are in general stationary, the inter-network device ranging measurement may not need to be repeated frequently unless changes in the location of the network devices are observed.

The GNSS receivers in the network devices may have different clock errors. In further embodiments, to address the non-uniform receiver clock error, network devices may perform over-the-air time synchronization (e.g., via UWB or FTM, etc.). In still more embodiments, the pulse-position modulated (PPM) output of the UWB module can be connected to the GNSS mixer. After synchronization, all the pseudorange measurements may have the same time/distance (time-distance) offset. In still further embodiments, any localization technique can be utilized to determine the network device locations based on the pseudoranges. By way of non-limiting examples, a least squares (LS) estimator or a maximum likelihood (ML) estimator can be utilized for the geo-positioning process. In still additional embodiments, the (synchronized) receiver clock error (e.g., the receiver time ambiguity) may be treated as another variable to be estimated in the localization process. In some more embodiments, the location solver (which can be implemented at the central unit and performs the calculations to determine the locations of the network devices) may be executed for each time epoch. In certain embodiments, in a post-processing or filtering operation, the location solver can calculate the total range residual error per node (e.g., per network device). The range residual can be defined as the difference of the measured range from the range from the estimated geo-position. For each node, the estimated geo-position with the minimum (least) total residual error may be selected and kept. In yet more embodiments, instead of executing the location solver for each time epoch, the location solver may be executed just once after the long GNSS data is collected. Just the pseudorange measurements corresponding to the maximum (greatest) C/N0 metric may be utilized in the localization process.

In still yet more embodiments, to mitigate the impact of multipath and improve accuracy, pseudoranges measurements whose quality metrics are below a threshold may be filtered out. By way of non-limiting examples, pseudoranges measurements whose C/NO metrics and/or code-minus-carrier (CMC) metrics (which may characterize and measure code multipath errors by subtracting carrier phase measurements from corresponding pseudorange measurements) are below a predetermined threshold can be discarded. In many further embodiments, each position of satellite in each time epoch can be considered as a new anchor (while the geo-position of the network devices may be presumed to be static). Accordingly, pseudorange measurements corresponding to a great number of satellite anchors (e.g., thousands) can be combined for a single solution and the impact of multipath can be minimized.

The time complexity of the location solver can be exponential with respect to the number of nodes (e.g., the number of network devices). Therefore, in many additional embodiments, a two-stage approach may be utilized, where a smaller number of network devices are involved in each of the two stages. The geolocation of anchor network devices may be estimated with high accuracy first in a first stage localization process. Then, the rest of the network devices (i.e., the non-anchor network devices) can be geolocalized in a second stage localization process. In still yet further embodiments, a network device may be selected as an anchor network device based on the number of (average) observable satellites at the network device (e.g., a network device with more observable satellites may be more likely to be selected as an anchor network device) and/or the number of inter-network device ranging measurement links to other network devices at the network device (e.g., a network device with more inter-network device ranging measurement links to other network devices may be more likely to be selected as an anchor network device). In particular, by way of a non-limiting example, the N network devices with the highest number of satellite links can be selected as anchor network devices. Joint geolocalization based on GNSS-based pseudorange measurements and territorial-based inter-network device ranging measurements can be solved for the N anchor network devices (e.g., with high accuracy). Thereafter, M more non-anchor network devices (which may suffer from a low number of satellite links and/or inter-network device ranging links) may be added into the location solver, and the geolocation of the M non-anchor network devices may be determined.

In still yet additional embodiments, pseudorange measurement data may be collected over a long, predefined time period (e.g., over a period that is longer than a threshold, e.g., 12 hours, 24 hours, etc.). The geo-position of the network devices can be determined after the period (e.g., 12 hours, 24 hours, etc.) is up based on the pseudorange measurement data collected over the period. In several embodiments, the filter (e.g., the threshold utilized for filtering out noisier pseudorange measurements) may be calculated per pseudorange measurement.

Therefore, embodiments of the disclosure may relate to estimating the geolocation of a group of network devices, based on jointly using inter-network device ranging measurements and pseudoranges to GNSS satellites. This approach can enhance both the availability and accuracy of geo-positioning, particularly for network devices deployed indoors where the line-of-sight to satellites is often obstructed. By way of non-limiting examples, the embodiments can be utilized in various indoor environments such as, but not limited to, office buildings, shopping malls, and/or residential complexes.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

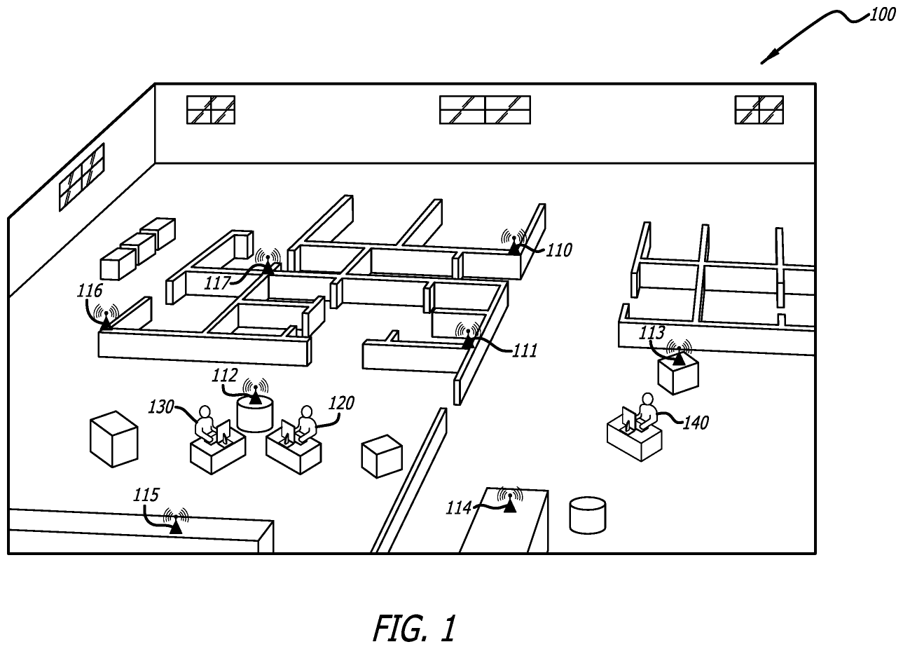

Referring to FIG. 1, a conceptual illustration of a floorplan 100 with a plurality of network devices in accordance with various embodiments of the disclosure is shown. Although the floorplan 100 depicted in the embodiment of FIG. 1 is an office environment, it is contemplated that a floorplan may be any environment that includes a plurality of network devices (e.g., APs) distributed throughout an area. In many embodiments, an area may have multiple floorplans and network devices may be associated with multiple floorplans. Indeed, in a number of embodiments, a floorplan may be defined as a collection of network devices and the area that those network devices cover.

In the embodiments depicted in FIG. 1, the floorplan 100 has a first network device 110 at an entranceway to the area. Likewise, a second network device 111 can be placed centrally within the floorplan 100. Within the floorplan 100, three people are depicted working at desk workstations. The first person 120 and second person 130 are working next to a third network device 112. A third person 140 is working next to a fourth network device 113. Additional network devices are distributed throughout the floorplan 100 to provide additional wireless signal coverage including a fifth network device 114, a sixth network device 115, a seventh network device 116, and an eighth network device 117.

The geo-positions of the network devices 110 through 117 can be useful for various applications, such as, but not limited to, indoor navigation, asset tracking, or location-based services. The network devices 110 through 117 may be equipped with GNSS receivers to receive signals from GNSS satellites for geolocation estimation. However, not all network devices may have a clear line-of-sight to the GNSS satellites. In the embodiments depicted in FIG. 1, among the network devices, network devices 110, 116, and 117 may be located closer to the windows 150 and therefore can potentially have a line-of-sight to the GNSS satellites. These network devices 110, 116, and 117 may be able to receive the GNSS satellite signals directly.

On the other hand, the other network devices 111, 112, 113, 114, and 115 may be located further away from the windows 150; accordingly, their line-of-sight to the GNSS satellites may be obstructed by the indoor environment (e.g., by walls or other objects present in the indoor environment). This can lead to issues such as signal attenuation, multipath propagation, or signal blockage, which can degrade the quality of the pseudorange measurements and may even render pseudorange measurements unattainable. In other words, the indoor environment can significantly impact the performance of GNSS-based geolocation estimation, making it difficult to obtain accurate and reliable geo-positions for all network devices.

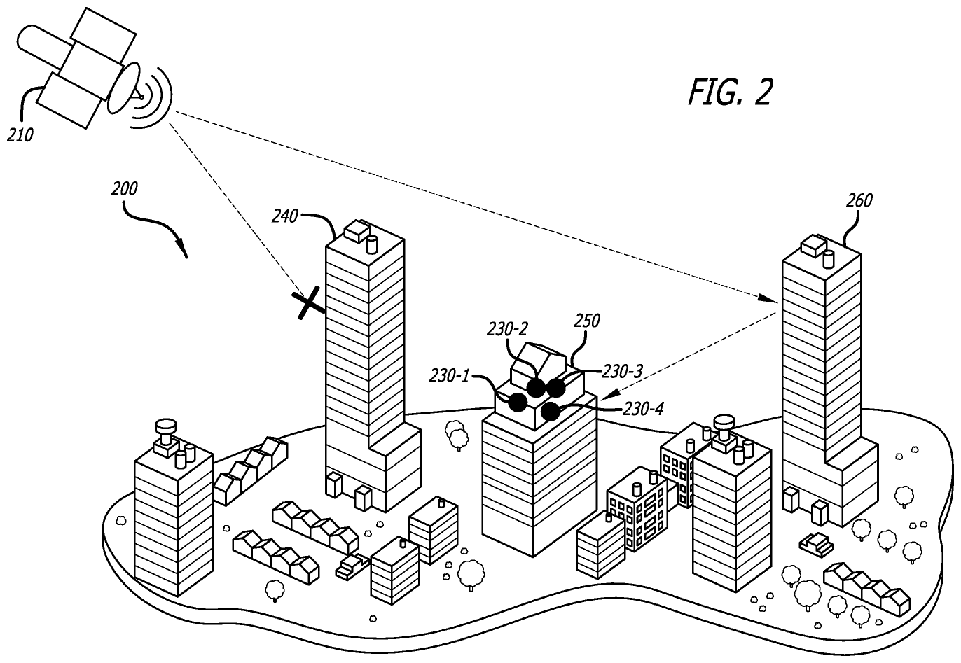

Although a specific embodiment for a floorplan with a plurality of network devices suitable for carrying out the various steps, processes, methods, and operations described herein is discussed with respect to FIG. 1, any of a variety of systems and/or processes may be utilized in accordance with embodiments of the disclosure. For example, the floorplan can include additional features such as walls or partitions of varying materials and thicknesses, which can affect the propagation of signals and thus the accuracy of geolocation estimation. The elements depicted in FIG. 1 may also be interchangeable with other elements of FIGS. 2-8 as required to realize a particularly desired embodiment.

Referring to FIG. 2, a conceptual illustration of a network 200 depicting non-line-of-sight to one or more GNSS satellites in accordance with various embodiments of the disclosure is shown. The network 200 can include a plurality of devices 230-1, 230-2, 230-3, and 230-4 (also referred to as “device 230” for simplicity). In many embodiments, the device 230 may be a network device (e.g., an AP). The network 200 may operate in a geographical area having one or more structures, for instance, buildings, houses, bridges, or sheds etc. In the embodiments depicted in FIG. 2, the device 230 may be located in an indoor environment in the building 250.

The device 230 may include at least one GNSS receiver that may receive signals from GNSS satellites (e.g., the GNSS satellite 210). The GNSS receiver can be configured to determine a geolocation of the device 230, if satisfactory pseudorange measurements can be obtained based on received GNSS satellite signals. As described above, a device 230 located further away from the window may have its line-of-sight to the GNSS satellites obstructed. Further, even if a device 230 is located close to one or more windows, as the cases may be with the devices 230-1, 230-2, 230-3, and 230-4 as shown in the embodiments depicted in FIG. 2, the device 230 may still not have a direct line-of-sight to the GNSS satellites. By way of non-limiting examples, in the embodiments depicted in FIG. 2, the devices 230-1 and 230-2 may not have a direct line-of-sight to the GNSS satellite 210 due to the blockage caused by the building 240. Further, although devices 230-3 and 230-4 can receive signals from the GNSS satellite 210, the signals may not be received in the line-of-sight condition as they may have been reflected by the building 260 before reception. As described above, the absence of the line-of-sight to the GNSS satellites can lead to issues such as signal attenuation, multipath propagation, or signal blockage, which can degrade the quality of the pseudorange measurements and may even render pseudorange measurements unattainable.

Although a specific embodiment for a network depicting non-line-of-sight to one or more GNSS satellites suitable for carrying out the various steps, processes, methods, and operations described herein is discussed with respect to FIG. 2, any of a variety of systems and/or processes may be utilized in accordance with embodiments of the disclosure. For instance, the network may be configured to account for dynamic changes in the environment that can affect the line-of-sight conditions. The elements depicted in FIG. 2 may also be interchangeable with other elements of FIGS. 1 and 3-8 as required to realize a particularly desired embodiment.

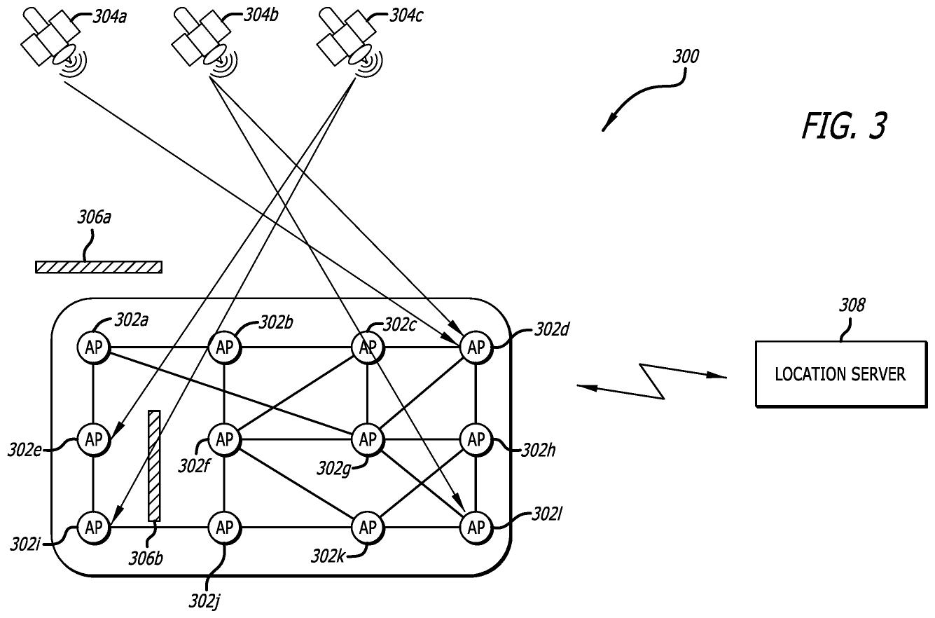

Referring to FIG. 3, a diagram illustrating a system environment 300 in accordance with various embodiments of the disclosure is shown. The embodiments depicted in FIG. 3 show the geolocation estimation process for network devices (e.g., APs) using both pseudorange measurements from GNSS satellites and terrestrial-based inter-network device ranging measurements between network devices. The pseudorange measurements from GNSS satellites and the terrestrial-based inter-network device ranging measurements may be fused together in the geolocalization process. The network devices 302a-l may be positioned indoors. In many embodiments, at least some of the network devices 302a-l may each be equipped with a GNSS receiver that collects pseudorange data from satellite links at time intervals. By way of a non-limiting example, the network device 302d can make pseudorange measurements to observable GNSS satellites 304a and 304b in each time epoch. In the embodiments shown in FIG. 3, due to the presence of obstacles, just network devices 302e, 302i, 302d, and 3021 may be able to observe GNSS satellites. By way of a non-limiting example, an outdoor obstacle 306a (e.g., a building, such as the building 240 shown in FIG. 2) can obstruct the network device 302a from observing any GNSS satellites. Each network device collecting pseudorange data can report the respective pseudorange data to the location server 308 (which may correspond to a central unit).

In a number of embodiments (not shown), the location server 308 may be co-located or implemented at one of the network devices being geolocalized. In a variety of embodiments, the pseudorange data can be timestamped based on the satellite time, which may, by way of a non-limiting example, include a TOW and a week number. The timestamped pseudorange data, along with other data such as the C/NO metric and/or the satellite ID (and/or the constellation ID), may be reported to the location server 308.

In some embodiments, the location server 308 may receive the ephemeris (i.e., the satellite navigation data) from network devices (e.g., some of the network devices 302a-1), or from a separate server (e.g., a PPP server). In more embodiments, the network devices 302a-l can also obtain and collect terrestrial-based inter-network device ranging measurements (e.g., based on FTM, UWB, or HADM, etc.) between each other. By way of a non-limiting example, the network device 302a may have inter-network device ranging measurement links with the network devices 302b, 302g, and 302e. The formation of inter-network device ranging measurement links can be affected by the distance between network devices and/or by obstacles. By way of a non-limiting example, an indoor obstacle 306b can prevent the establishment of inter-network device ranging measurement links between certain pairs of devices (e.g., between the network device 302e and each of the network devices 302b, 302f, or 302j).

In additional embodiments, to address the non-uniform receiver clock error, network devices (e.g., at least some of the network devices 302a-1) may perform over-the-air time synchronization. After synchronization, all the pseudorange measurements may have the same time/distance offset. In further embodiments, any suitable localization technique can be utilized to determine the network device geolocations based jointly on the pseudorange measurements and the inter-network device ranging measurements. By way of non-limiting examples, an LS estimator or a maximum likelihood (ML) estimator can be utilized for the geo-positioning process. In particular, the location server 308 may perform the calculations to determine the geolocations of the network devices 302a-1. In still more embodiments, the (synchronized) receiver clock error (e.g., the receiver time ambiguity) may be treated (e.g., by the location server 308) as another variable to be estimated in the localization process.

In still further embodiments, the location solver, which can be implemented at the location server 308 and can perform the calculations to determine the locations of the network devices 302a-1, may be executed for each time epoch. In still additional embodiments, in a post-processing or filtering operation, the location solver can calculate the total range residual error per node (e.g., per network device). For each node, the estimated geo-position with the minimum (least) total residual error may be selected and kept. In some more embodiments, instead of executing the location solver for each time epoch, the location solver may be executed just once after the long GNSS data is collected. Just the pseudorange measurements corresponding to the maximum (greatest) C/NO metric may be utilized in the localization process.

In certain embodiments, to mitigate the impact of multipath and improve accuracy, pseudoranges measurements whose quality metrics are below a threshold may be filtered out. By way of non-limiting examples, pseudoranges measurements whose C/NO metrics and/or CMC metrics are below a predetermined threshold can be discarded. In yet more embodiments, each position of satellite in each time epoch can be considered as a new anchor. Accordingly, pseudorange measurements corresponding to a great number of satellite anchors can be combined for a single solution and the impact of multipath can be minimized.

In still yet more embodiments, a two-stage approach may be utilized, where the geolocation of anchor network devices may be estimated (with high accuracy) first in a first stage localization process. Then, the rest of the network devices (i.e., non-anchor network devices) can be geolocalized in a second stage localization process. In many further embodiments, a network device may be selected as an anchor network device based on the number of (average) observable satellites at the network device and/or the number of inter-network device ranging measurement links to other network devices at the network device. Therefore, by way of a non-limiting example, network devices 102d, 102f, 102g, 102i, and 102l may be selected as anchor network devices based on their higher number of observable satellites and/or higher number of inter-network device ranging measurement links. The geolocation of anchor network devices 102d, 102f, 102g, 102i, and 102l may be estimated with high accuracy first in a first stage localization process. Thereafter, the non-anchor network devices 102a, 102b, 102c, 102e, 102h, 102j, and 102k can be added to the location solver. The geo-position of the non-anchor network devices 102a, 102b, 102c, 102e, 102h, 102j, and 102k can be estimated in a second stage localization process.

In many additional embodiments, pseudorange measurement data may be collected over a long, predefined time period (e.g., 12 hours, 24 hours, etc.). The geo-position of the network devices 302a-l can be determined after the period is up based on the pseudorange measurement data collected over the period. In still yet further embodiments, the filter (e.g., the threshold utilized for filtering out noisier pseudorange measurements) may be calculated per pseudorange measurement.

Although a specific embodiment for a system environment suitable for carrying out the various steps, processes, methods, and operations described herein is discussed with respect to FIG. 3, any of a variety of systems and/or processes may be utilized in accordance with embodiments of the disclosure. For example, the network devices can be equipped with advanced GNSS receivers capable of receiving signals from multiple satellite systems simultaneously, thereby increasing the number of observable satellites and enhancing the accuracy of geolocation estimation. The elements depicted in FIG. 3 may also be interchangeable with other elements of FIGS. 1, 2, and 4-8 as required to realize a particularly desired embodiment.

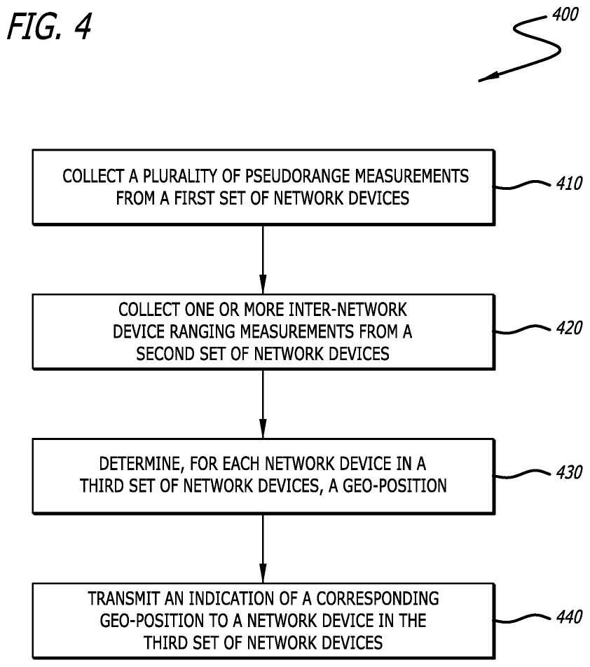

Referring to FIG. 4, a flowchart showing a process 400 for estimating the geolocation of network devices using pseudorange measurements and inter-network device ranging measurements in accordance with various embodiments of the disclosure is shown. In many embodiments, the process 400 may collect a plurality of pseudorange measurements from a first set of network devices (block 410). The pseudorange measurements can be obtained from signals received from GNSS satellites. Each network device in the first set of network devices may include a respective GNSS receiver for obtaining one or more pseudorange measurements.

In a number of embodiments, the process 400 may collect one or more inter-network device ranging measurements from a second set of network devices (block 420). The second set of network devices can share at least one network device with the first set of network devices. The inter-network device ranging measurements can be obtained from signals exchanged between network devices (e.g., based on FTM, UWB, or HADM, etc.). The network devices in the second set may be equipped with transceivers to send and receive these signals. The inter-network device ranging measurements can provide information about the relative distances between network devices.

In a variety of embodiments, the process 400 can determine, for each network device in a third set of network devices, a geo-position (block 430). The third set of network devices may include one or more first network devices in the first set of network devices and one or more second network devices in the second set of network devices. The determination can be based at least in part on the pseudorange measurements collected from the first set of network devices and the inter-network device ranging measurements collected from the second set of network devices. The geo-position can be estimated utilizing various localization techniques that take into account the pseudorange measurements and the inter-network device ranging measurements.

In some embodiments, the process 400 can transmit an indication of a corresponding geo-position to a network device in the third set of network devices (block 440). The transmission can be carried out over a network connection. The network device can use the received geo-position for various applications, such as, but not limited to, location-based services.

Although a specific embodiment for estimating the geolocation of network devices using pseudorange measurements and inter-network device ranging measurements suitable for carrying out the various steps, processes, methods, and operations described herein is discussed with respect to FIG. 4, any of a variety of systems and/or processes may be utilized in accordance with embodiments of the disclosure. For example, additional operations such as, but not limited to, error correction or filtering may be utilized to improve the accuracy of the geolocation estimation. The elements depicted in FIG. 4 may also be interchangeable with other elements of FIGS. 1-3 and 5-8 as required to realize a particularly desired embodiment.

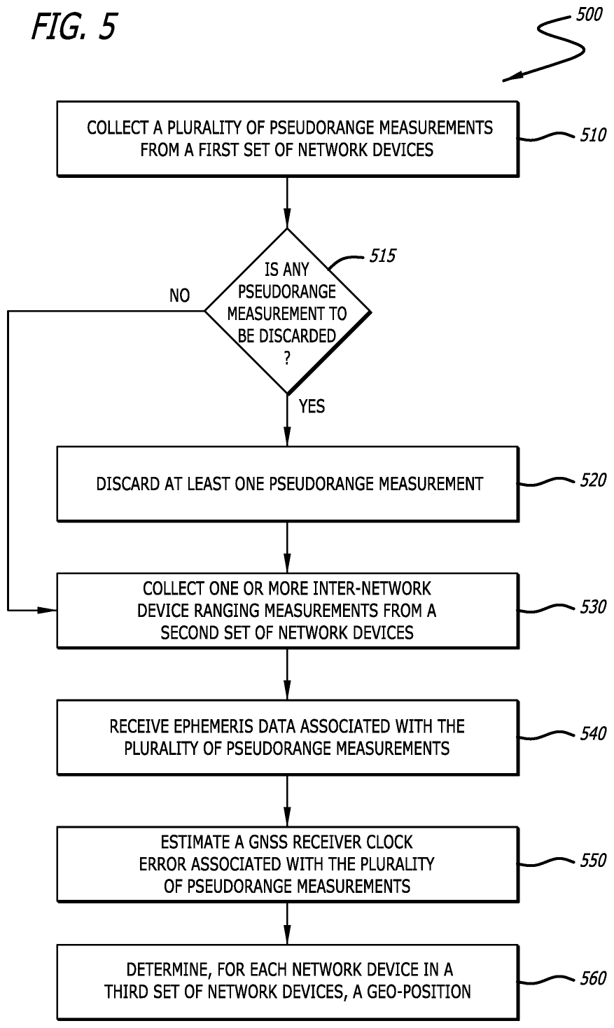

Referring to FIG. 5, a flowchart showing a process 500 for estimating the geolocation of network devices using pseudorange measurements and inter-network device ranging measurements in accordance with various embodiments of the disclosure is shown. In many embodiments, the process 500 may collect a plurality of pseudorange measurements from a first set of network devices (block 510). The pseudorange measurements can be obtained from signals received from GNSS satellites. Each network device in the first set of network devices may include a respective GNSS receiver for obtaining one or more pseudorange measurements.

In a number of embodiments, the process 500 can determine if any pseudorange measurement is to be discarded (block 515). This determination can be based on various factors, such as, but not limited to, the quality of the pseudorange measurements, the signal strength, or the presence of errors or anomalies in the measurements. In a variety of embodiments, in response to the determination that at least one pseudorange measurement is to be discarded, the process 500 can discard at least one pseudorange measurement. This can help to improve the accuracy of the geolocation estimation by removing potentially erroneous or unreliable data. However, in some embodiments, when the determination is that no pseudorange measurement is to be discarded, the process 500 can proceed to collect one or more inter-network device ranging measurements from a second set of network devices.

In more embodiments, in response to the determination that at least one pseudorange measurement is to be discarded, the process 500 can discard at least one pseudorange measurement (block 520). The discarding of the at least one pseudorange measurement can be based on the quality metric associated with the at least one pseudorange measurement being less than a threshold. In additional embodiments, the quality metric may include a C/NO metric or a CMC metric.

In further embodiments, the process 500 can collect one or more inter-network device ranging measurements from a second set of network devices (block 530). The second set of network devices can share at least one network device with the first set of network devices. The inter-network device ranging measurements can be obtained from signals exchanged between network devices (e.g., based on FTM, UWB, or HADM, etc.). The network devices in the second set may be equipped with transceivers to send and receive these signals. The inter-network device ranging measurements can provide information about the relative distances between network devices.

In still more embodiments, the process 500 can receive ephemeris data associated with the plurality of pseudorange measurements (block 540). The ephemeris data can relate to the orbits of the GNSS satellites. The ephemeris data may be received via the first set of network devices or from a PPP server.

In still further embodiments, the process 500 can estimate a GNSS receiver clock error associated with the plurality of pseudorange measurements (block 550). The GNSS receiver clock error may represent the time difference between the (synchronized) internal clocks at the GNSS receivers and the GNSS system time, which can introduce a bias into the pseudorange measurements. By treating the GNSS receiver clock error as an additional unknown variable in the estimation process, alongside the unknown geolocations of the network devices, the location solver can estimate the GNSS receiver clock error as well as the geolocation of the network devices.

In still additional embodiments, the process 500 can determine, for each network device in a third set of network devices, a geo-position (block 560). The third set of network devices may include one or more first network devices in the first set of network devices and one or more second network devices in the second set of network devices. The determination can be based at least in part on the pseudorange measurements collected from the first set of network devices and the inter-network device ranging measurements collected from the second set of network devices. The geo-position can be estimated utilizing various localization techniques that take into account the pseudorange measurements and the inter-network device ranging measurements.

Although a specific embodiment for estimating the geolocation of network devices using pseudorange measurements and inter-network device ranging measurements suitable for carrying out the various steps, processes, methods, and operations described herein is discussed with respect to FIG. 5, any of a variety of systems and/or processes may be utilized in accordance with embodiments of the disclosure. For instance, the geolocalization process may incorporate additional data sources, such as inertial measurement units or barometric pressure sensors, to further enhance the accuracy of the geolocation estimation. The elements depicted in FIG. 5 may also be interchangeable with other elements of FIGS. 1-4 and 6-8 as required to realize a particularly desired embodiment.

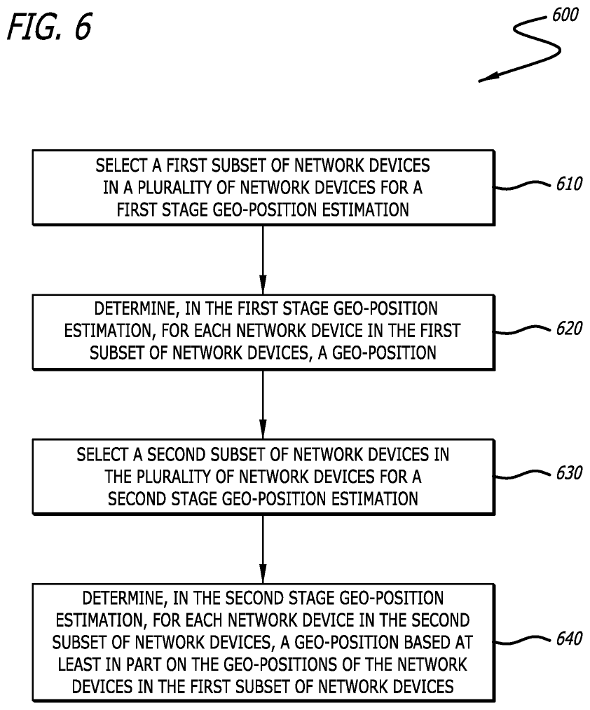

Referring to FIG. 6, a flowchart showing a process 600 for estimating the geolocation of network devices using a two-stage approach in accordance with various embodiments of the disclosure is shown. In many embodiments, the process 600 may select a first subset of network devices in a plurality of network devices for a first stage geo-position estimation (block 610). The selection can be based on various factors, such as, but not limited to, the number of observable satellites at each network device and/or the number of inter-network device ranging measurement links at each network device. The first subset of network devices may include those devices that are expected to provide more and/or more reliable pseudorange measurements and/or inter-network device ranging measurements.

In a number of embodiments, the process 600 can determine, in the first stage geo-position estimation, for each network device in the first subset of network devices, a geo-position (block 620). The determination can be based jointly on the pseudorange measurements and the inter-network device ranging measurements collected from the network devices in the first subset of network devices. The geo-position can be estimated using various localization techniques that take into account the pseudorange measurements and the inter-network device ranging measurements.

In a variety of embodiments, the process 600 can select a second subset of network devices in the plurality of network devices for a second stage geo-position estimation (block 630). The selection can be based on various factors, such as, but not limited to, the number of observable satellites at each network device and/or the number of inter-network device ranging measurement links at each network device. The second subset of network devices may include those devices that have not been included in the first subset of network devices.

In some embodiments, the process 600 can determine, in the second stage geo-position estimation, for each network device in the second subset of network devices, a geo-position based at least in part on the geo-positions of the network devices in the first subset of network devices (block 640). In more embodiments, the determination can be based further on the inter-network device ranging measurements between network device pairs that span the first subset and the second subset. Accordingly, the process 600 can collect one or more additional inter-network device ranging measurements from a fourth set of network devices, where the fourth set of network devices may share one or more network devices with the third set of network devices, and may include one or more non-anchor network devices. The geo-position of each network device in the second subset can be estimated by combining the data using various localization techniques. In additional embodiments, the determination can be based further on the pseudorange measurements and/or the inter-network device ranging measurements collected from the network devices in the second subset of network devices.

Although a specific embodiment for estimating the geolocation of network devices using a two-stage approach suitable for carrying out the various steps, processes, methods, and operations described herein is discussed with respect to FIG. 6, any of a variety of systems and/or processes may be utilized in accordance with embodiments of the disclosure. For example, the process can be extended to include additional stages of geo-position estimation, each stage focusing on a different subset of network devices based on different selection criteria. The elements depicted in FIG. 6 may also be interchangeable with other elements of FIGS. 1-5, 7, and 8 as required to realize a particularly desired embodiment.

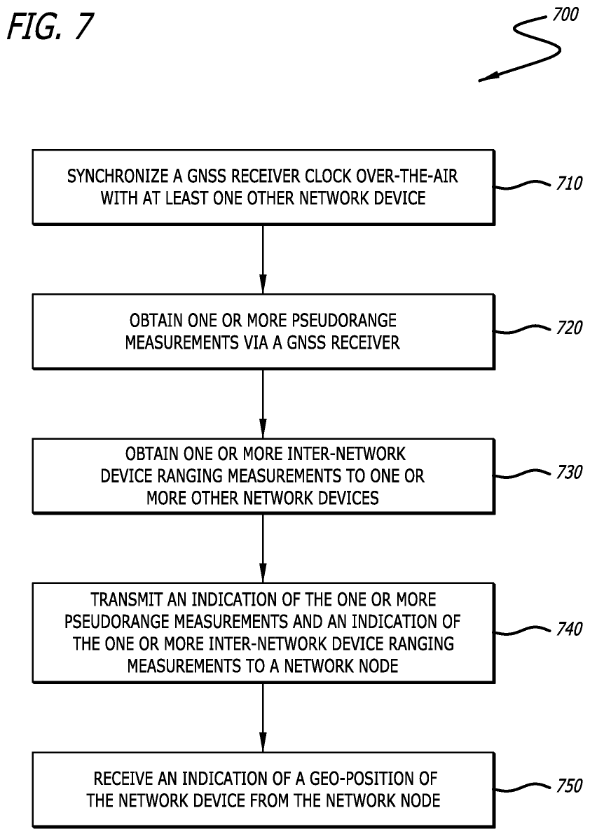

Referring to FIG. 7, a flowchart showing a process 700 for estimating the geolocation of a network device in accordance with various embodiments of the disclosure is shown. In many embodiments, the process 700 may synchronize a GNSS receiver clock over-the-air with at least one other network device (block 710). The synchronization can help to align the time bases of the network devices, thereby reducing the impact of clock errors on the pseudorange measurements. After synchronization, all the pseudorange measurements may have the same time/distance offset. The synchronization can be achieved using various techniques, such as exchanging timing signals or using a common reference clock signal.

In a number of embodiments, the process 700 can obtain one or more pseudorange measurements via a GNSS receiver (block 720). These pseudorange measurements can be obtained from signals received from GNSS satellites. The pseudorange measurements can be associated with one or more of quality metrics (e.g., a C/NO metric, or a CMC metric, etc.), timestamps (e.g., TOW and week numbers), or satellite/constellation IDs.

In a variety of embodiments, the process 700 can obtain one or more inter-network device ranging measurements to one or more other network devices (block 730). The measurements can be obtained from signals exchanged between network devices. Further, the measurements can be based on techniques such as, but not limited to, FTM, UWB, or HADM. The inter-network device ranging measurements can relate to the relative distances between network devices.

In some embodiments, the process 700 can transmit an indication of the one or more pseudorange measurements and an indication of the one or more inter-network device ranging measurements to a network node (block 740). This transmission can be carried out over a network connection. The network node may correspond to a location server, a central unit, and so on. The network node may be co-located or implemented at another network device being geolocalized, or may be implemented at a remote device not being geolocalized. The network node can use the measurements to estimate the geolocation of the network device.

In more embodiments, the process 700 can receive an indication of a geo-position of the network device from the network node (block 750). The geo-position can be based on the pseudorange measurements and the inter-network device ranging measurements. The network device can use the received geo-position for various applications, such as, but not limited to, location-based services.

Although a specific embodiment for estimating the geolocation of a network device suitable for carrying out the various steps, processes, methods, and operations described herein is discussed with respect to FIG. 7, any of a variety of systems and/or processes may be utilized in accordance with embodiments of the disclosure. For example, the network devices may be selectively activated based on their signal quality, thereby optimizing the use of network resources, and improving the accuracy of the geolocation estimation. The elements depicted in FIG. 7 may also be interchangeable with other elements of FIGS. 1-6 and 8 as required to realize a particularly desired embodiment.

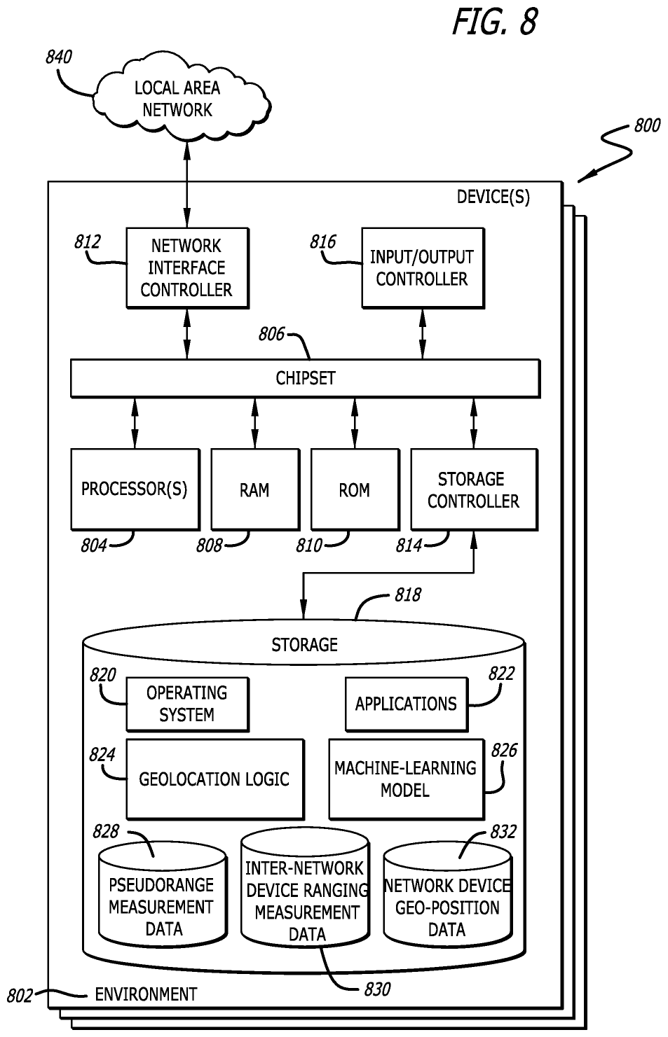

Referring to FIG. 8, a conceptual block diagram for one or more devices 800 capable of executing components and logic for implementing the functionality and embodiments described above is shown. The embodiment of the conceptual block diagram depicted in FIG. 8 can illustrate a conventional server computer, workstation, desktop computer, laptop, tablet, network appliance, e-reader, smartphone, or other computing device, and can be utilized to execute any of the application and/or logic components presented herein. The device 800 may, in some examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, applications 822, pseudorange measurement data 828, inter-network device ranging measurement data 830, and network device geo-position data 832, which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiment, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8, and can include other components that are not explicitly shown in FIG. 8, or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many embodiments, the device 800 can include a geolocation logic 824. The geolocation logic 824 may process the pseudorange measurements and inter-network device ranging measurements to estimate the geolocation of network devices. The geolocation logic 824 can utilize various processes and techniques, such as LS or maximum likelihood (ML) estimation, to compute the most probable geolocation of the network devices based on the available measurements.

In a number of embodiments, the storage 818 can include pseudorange measurement data 828. The pseudorange measurement data 828 may be data collected from signals received from GNSS satellites by the network devices. The pseudorange measurement data 828 can be utilized, jointly with the inter-network device ranging measurement data 830, to estimate the geolocation of the network devices.

In various embodiments, the storage 818 can include inter-network device ranging measurement data 830. The inter-network device ranging measurement data 830 may be data collected from signals exchanged between network devices. The inter-network device ranging measurement data 830 can relate to the relative distances between network devices, which can be utilized, jointly with the pseudorange measurement data 828, to estimate the geolocation of the network devices.

In still more embodiments, the storage 818 can include network device geo-position data 832. The network device geo-position data 832 may relate to the estimated geolocation of each network device, as determined by the geolocation logic 824. The network device geo-position data 832 can include the latitude, longitude, and potentially altitude of each network device, and can be used for various applications such as, but not limited to, location-based services.

Finally, in many embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to predict the quality of pseudorange measurements and inter-network device ranging measurements, aiding in the selection of the most reliable data for geolocation estimation.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network node, comprising:
a processor;
at least one network interface controller configured to provide access to a network; and
a memory communicatively coupled to the processor, wherein the memory comprises a geolocation logic that is configured to:
collect a plurality of pseudorange measurements from a first set of network devices, each network device in the first set of network devices including a respective global navigation satellite system (GNSS) receiver for obtaining one or more pseudorange measurements;
collect one or more inter-network device ranging measurements from a second set of network devices, the second set of network devices sharing at least one network device with the first set of network devices; and
determine, for each network device in a third set of network devices, a geo-position based at least in part on at least some of the plurality of pseudorange measurements and at least some of the one or more inter-network device ranging measurements, the third set of network devices including one or more first network devices in the first set of network devices and one or more second network devices in the second set of network devices.

2. The network node of claim 1, wherein at least one network device in the first set of network devices or the second set of network devices corresponds to an access point (AP).

3. The network node of claim 1, wherein the plurality of pseudorange measurements is collected during one or more time intervals.

4. The network node of claim 1, wherein each pseudorange measurement in the plurality of pseudorange measurements is associated with a timestamp.

5. The network node of claim 1, wherein each pseudorange measurement in the plurality of pseudorange measurements is associated with a satellite identifier (ID) or a constellation ID.

6. The network node of claim 1, wherein each pseudorange measurement in the plurality of pseudorange measurements is associated with a quality metric.

7. The network node of claim 6, wherein the geolocation logic is further configured to discard at least one pseudorange measurement based on the quality metric associated with the at least one pseudorange measurement being less than a threshold.

8. The network node of claim 6, wherein the quality metric includes a carrier-to-noise power density ratio (C/N0) metric or a code-minus-carrier (CMC) metric.

9. The network node of claim 1, wherein the geolocation logic is further configured to receive ephemeris data associated with the plurality of pseudorange measurements.

10. The network node of claim 9, wherein the ephemeris data is received via the first set of network devices.

11. The network node of claim 9, wherein the ephemeris data is received from a precise point positioning (PPP) server.

12. The network node of claim 1, wherein the plurality of pseudorange measurements is associated with synchronized GNSS receiver clocks at the first set of network devices, and the plurality of pseudorange measurements is associated with a same time-distance offset.

13. The network node of claim 12, wherein to determine the geo-position, the geolocation logic is further configured to estimate a GNSS receiver clock error associated with the plurality of pseudorange measurements.

14. The network node of claim 1, wherein each network device in the third set of network devices is an anchor network device, and the geolocation logic that is further configured to:
collect one or more additional inter-network device ranging measurements from a fourth set of network devices, the fourth set of network devices sharing one or more network devices with the third set of network devices, the fourth set of network devices including one or more non-anchor network devices; and
determine, for each non-anchor network device in the one or more non-anchor network devices, a non-anchor geo-position based at least in part on at least some of the one or more additional inter-network device ranging measurements.

15. The network node of claim 14, wherein a number of observable satellites associated with each anchor network device is greater than a first threshold.

16. The network node of claim 14, wherein a number of ranging links associated with each anchor network device is greater than a second threshold.

17. The network node of claim 1, wherein the one or more inter-network device ranging measurements are based on at least one of fine time measurement (FTM), ultra-wideband (UWB), or high-accuracy distance measurement (HADM).

18. A network device, comprising:
a processor;
at least one network interface controller configured to provide access to a network; and
a memory communicatively coupled to the processor, wherein the memory comprises a geolocation logic that is configured to:
obtain one or more pseudorange measurements via a global navigation satellite system (GNSS) receiver;
obtain one or more inter-network device ranging measurements to one or more other network devices;
transmit an indication of the one or more pseudorange measurements and an indication of the one or more inter-network device ranging measurements to a network node; and
receive an indication of a geo-position of the network device from the network node.

19. The network device of claim 18, wherein the geolocation logic is further configured to synchronize a GNSS receiver clock over-the-air with at least one other network device.

20. A method for joint geolocating, comprising:
collecting a plurality of pseudorange measurements from a first set of network devices, each network device in the first set of network devices including a respective global navigation satellite system (GNSS) receiver for obtaining one or more pseudorange measurements;
collecting one or more inter-network device ranging measurements from a second set of network devices, the second set of network devices sharing at least one network device with the first set of network devices; and
determining, for each network device in a third set of network devices, a geo-position based at least in part on at least some of the plurality of pseudorange measurements and at least some of the one or more inter-network device ranging measurements, the third set of network devices including one or more first network devices in the first set of network devices and one or more second network devices in the second set of network devices.
